(19) United States
(12) Patent Application Publication
(10) Pub. No.: US 2007/0064129 A1
(43) Pub. Date: Mar. 22, 2007

(54) Solid-state imaging device

(75) Inventor: Nobuo Suzuki, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/522,352

(22) Filed: Sep. 18, 2006

(30) Foreign Application Priority Data
Sep. 16, 2005 (JP) P.2005-269862

(51) Int. Cl. H04N 9/04

(52) U.S. Cl. 348/272

(57) ABSTRACT

A solid-state imaging device comprising pixels arranged in a row direction and a column direction, wherein each of the pixels comprises: (i) a light receiving portion including photoelectric converting elements which are formed overlappingly in a depth direction of a semiconductor substrate, and which detect lights of different colors respectively, and a photoelectric converting film which is stacked above the plural photoelectric converting elements, and which detects a light of a color different from the colors detected by the photoelectric converting elements; and (ii) a signal read circuit which reads out signals corresponding to the lights detected by the photoelectric converting elements and the photoelectric converting film, wherein the solid-state imaging device comprises: a first signal processing section which applies a predetermined signal process on signals read out from first signal read circuits in a part of the pixels; and a second signal processing section which applies the predetermined signal process on signals read out from second signal read circuits in pixels other than the part of the pixels.

### BACKGROUND OF THE INVENTION

1. Field of the Invention

The present invention relates to a solid-state imaging device having many pixels which are arranged in a row direction and a column direction perpendicular to the row direction.

2. Description of the Related Art

In a single-type solid-state color imaging device which is typified by a CCD or CMOS image sensor, three or four kinds of color filters are arranged in a mosaic-like manner on the arrangement of light receiving portions which perform photoelectric conversion. According to the configuration, each of the light receiving portions outputs a color signal corresponding to the color filter, and the color signals are signal-processed to produce a color image.

In a color imaging device in which color filters are arranged in a mosaic-like manner, in the case of filters of the primary colors, however, about two thirds of incident light is absorbed by the color filters, and there arises a problem in that the light use efficiency is poor and the sensitivity is low. Since each light receiving portion can produce only a color signal of one color, there are other problems in that also the resolution is poor, and that a false color is particularly conspicuous.

In order to solve such problems, an imaging device having a structure in which three photoelectric converting films are stacked on a semiconductor substrate on which signal read circuits are formed has been researched and developed (for example, JP-T-2002-502120 and JP-A-2002-83946 below). The imaging device comprises light receiving portions each having a structure in which, for example, photoelectric converting films that generate signal charges (electrons, holes) with respect to lights of blue (B), green (G), and red (R) are sequentially stacked with starting from a light incident face. Furthermore, signal read circuits which can independently read out signal charges that are optically generated in the photoelectric converting films are disposed respectively in the light receiving portions.

In an imaging device having this structure, most of incident light is photoelectrically converted to be read out as a signal, the utilization efficiency of visible light is about 100%, and three color signals of R, G, and B are obtained in each of the light receiving portions. Therefore, the device can produce an image of high resolution (a false color is inconspicuous) with high sensitivity.

In an imaging device disclosed in JP-T-2002-513145 below, a triple well (photodiodes) which detects light signals is disposed in a silicon substrate, and, according to depth differences in the silicon substrate, signals having different spectral sensitivities (having peaks at wavelengths of B (blue), G (green), and R (red) with starting from the surface) are obtained. This uses a phenomenon that the penetration distance of incident light into the silicon substrate depends on the wavelength. In the same manner as the imaging devices disclosed in JP-T-2002-502120 and JP-A-2002-83946, also the imaging device can produce an image of high resolution (a false color is inconspicuous) with high sensitivity.

In the imaging devices disclosed in JP-T-2002-502120 and JP-A-2002-83946, it is necessary to sequentially stack the three photoelectric converting films on the semiconductor substrate, and form longitudinal lines through which signal charges of R, G, and B and generated in the photoelectric converting films are connected the signal read circuits formed in the semiconductor substrate, respectively. The devices are hardly produced, and the production yield is low. Consequently, there is a problem in that the production cost is high.

By contrast, the imaging device disclosed in JP-T-2002-513145 has the structure in which blue light is detected by the shallowest photodiode, red light is detected by the deepest photodiode, and green light is detected by the intermediate photodiode. In the shallowest photodiode, for example, photo-charges are generated also by green light and red light. Consequently, there arises a problem in that spectral sensitivity characteristics for R, G, and B signals are not sufficiently separated from one another, and color reproducibility is poor. In order to obtain real R, G, and B signals, output signals from the photodiodes must be subjected to the adding and subtracting processes. There is another problem in that the S/N ratio of the image signal is impaired by the adding and subtracting processes.

As an imaging device which can solve the above-discussed problems of the imaging devices of JP-T-2002-502120, JP-A-2002-83946, and JP-T-2002-513145, an imaging device disclosed in JP-A-2003-332551 has been proposed. The disclosed imaging device is a hybrid device of the imaging devices of JP-T-2002-502120 and JP-A-2002-83946, and JP-T-2002-513145, and has a structure in which only one photoelectric converting film having a sensitivity at green (G) is stacked on a semiconductor substrate, and incident lights of blue (B) and red (R) which have passed through the photoelectric converting film are received by a photodiode formed in the semiconductor substrate in the same manner as the related-art image sensor.

Since only one photoelectric converting film is required, the production steps are simplified, and it is possible to avoid an increase of the production cost and a reduction of the production yield. Since green light is absorbed by the photoelectric converting film, separation of the spectral sensitivity characteristics of the photodiodes for blue and red in the semiconductor substrate is improved. Therefore, the device has advantages that color reproducibility is excellent, and that the S/N ratio is improved.

A hybrid imaging device such as disclosed by JP-A-2003-332551 has advantages that the production cost is low, that color reproducibility is improved, and that the S/N ratio is improved, but has other problems as follows. As a signal read circuit disposed in a semiconductor substrate of a hybrid imaging device, there are a CCD signal read circuit (a charge transfer path, a transfer electrode, and the like), and a CMOS signal read circuit (a MOS transistor, a signal line, and the like). In the following, the description is limited to a CMOS signal read circuit. A portion which includes a light receiving portion and a signal read circuit is defined as one pixel.

(1) There is a light receiving portion which detects three colors or RGB for one pixel, and hence the number of column signal lines is three times that of a single-type imaging device. In the case of a single-type CMOS imaging device, one signal process circuit unit for applying a signal process such as correlation dual sampling or a digital conversion process on a signal obtained from the photodiode is disposed for each column signal line on the semiconductor substrate. In the case of a hybrid imaging device, the number of column signal lines is three times that of a single-type device. When the same pixel number is to be realized in the same area as a single-type device, it is necessary to triplicate the integration degree of signal process circuit units as compared with a single-type device. However, a signal process circuit unit includes an analog amplifier and a CDS circuit, and occupies a large area. Therefore, it is difficult to triplicate the integration degree while maintaining the chip size. As a result, in order to maintain the chip size, the pixel number must be reduced, and this causes the resolution to be lowered.

(2) Since there is a light receiving portion which detects three colors or RGB for one pixel, the number of signal read circuits is three times that of a single-type imaging device. In a hybrid imaging device, in one pixel, two photodiodes and three signal read circuits are closely disposed in the semiconductor substrate. When the areas of the signal read circuits are increased, therefore, those of the two photodiodes are inevitably reduced. Consequently, the sensitivities and saturation outputs of R and B lights detected by the photodiodes are low, and the S/N ratios of the R and B signals are impaired. In a hybrid imaging device, the aperture ratio of a photoelectric converting film for detecting G light is about 100%. Therefore, the sensitivity of the G signal is high, and the S/N ratio is excellent. When the S/N ratios of the R and B signals are reduced, however, the image quality (S/N ratio) of the whole is impaired.

As described above, in the case where a CMOS signal read circuit is used in a hybrid imaging device, it is difficult to realize an increased number of pixels and high sensitivity.

### SUMMARY OF THE INVENTION

The invention has been conducted in view of the circumstances. It is an object of the invention to easily realize an increased number of pixels and high sensitivity in a hybrid solid-state imaging device.

The solid-state imaging device of the invention is a solid-state imaging device comprising a plurality of pixels which are arranged in a row direction and a column direction perpendicular to the row direction, wherein each of said plurality of pixels comprises: (i) a light receiving portion including a plurality of photoelectric converting elements which are formed overlappingly in a depth direction of a semiconductor substrate, and which detect lights of different colors respectively, and a photoelectric converting film which is stacked above the plural photoelectric converting elements in the semiconductor substrate, and which detects a light of a color different from the colors that are detected by said plurality of photoelectric converting elements; and (ii) a signal read circuit which reads out signals corresponding to the lights that are detected by said plurality of photoelectric converting elements and the photoelectric converting film, wherein the solid-state imaging device comprises: a first signal processing section which applies a predetermined signal process on signals read out from first signal read circuits that are signal read circuits included in a part of said plurality of pixels; and a second signal processing section which applies the predetermined signal process on signals read out from second signal read circuits that are signal read circuits included in pixels other than the part of said plurality of pixels.

According to the configuration, in the signal processing sections, the degree of circuit integration can be lowered, and the number of wirings can be reduced. Therefore, an increased number of pixels and high sensitivity can be easily realized.

In the solid-state imaging device of the invention, when a column comprising those of said plurality of pixels arranged in the column direction is indicated as a pixel column and a row comprising those of said plurality of pixels arranged in the row direction is indicated as a pixel row, said plurality of pixels comprises a plurality of pixel columns arranged in the row direction or comprises a plurality of pixel rows arranged in the column direction, the part of said plurality of pixels comprises pixels included in a part of said plurality of pixel columns, the solid-state imaging device further comprises: a driving signal supplying section that supplies to the signal read circuit a driving signal for driving the signal read circuit so as to read out signals from the pixels, in a unit of one pixel row; and a signal combining section that combines an output signal of the first signal processing section with an output signal of the second signal processing section so as to output signals obtained from the one pixel row which has been processed by the first signal processing section and the second signal processing section, in a sequence of pixels from which the signals are originated.

According to the configuration, as compared with the case where one signal processing section is disposed, the integration degree of the signal processing sections can be reduced. Even when the pixel pitch is narrowed and as a result the signal process circuit units in the signal processing sections are increased, it is possible to cope with the increase in a state where the integration degree in the case where one signal processing section is disposed is maintained. Therefore, it is possible to provide a solid-state imaging device in which miniaturization and the increased number of pixels are compatible with each other.

In the solid-state imaging device of the invention, the signal combining section simultaneously outputs signals obtained from one pixel, from output terminals which are disposed respectively for color components of the signals.

In the solid-state imaging device of the invention, the signal combining section outputs signals obtained from one pixel in a time sharing manner, from one output terminal.

According to the configuration, the number of terminals can be reduced.

In the solid-state imaging device of the invention, the part of said plurality of pixel columns is a half of said plurality of pixel columns.

In the solid-state imaging device of the invention, the signal read circuit comprises three or four MOS transistors.

In the solid-state imaging device of the invention, when a column comprising those of said plurality of pixels arranged in the column direction is indicated as a pixel column and a row comprising those of said plurality of pixels arranged in the row direction is indicated as a pixel row, said plurality of pixels comprises a plurality of pixel columns arranged in the row direction or comprises a plurality of pixel rows arranged in the column direction, the part of said plurality of pixels comprises pixels included in a half of said plurality of pixel rows, pixel rows in which pixels including the first signal read circuits are arranged, and pixel rows in which pixels including the second signal read circuits are arranged are alternately arranged in the column direction, each of the pixels further comprises a MOS switch that selectively outputs signals corresponding to the lights that are detected by said plurality of photoelectric converting elements and the photoelectric converting film, from the signal read circuit, and the solid-state imaging device further comprises a driving signal supplying section that supplies to the MOS switch and the signal read circuit, a driving signal for driving the MOS switch and the signal read circuit so as to sequentially read out signals from the pixels, in a unit of read pixel row comprising two pixel rows adjacent to each other in the column direction.

According to the configuration, the MOS switch is disposed, and hence the number of signal lines in which signals read by the signal read circuits flow can be suppressed to two per pixel column. One signal line is connected to the signal processing sections per pixel column. Therefore, the integration degree of the signal processing sections is not made large, so that the signal processing sections can be easily formed even when the pixel number is increased. By contrast, since the MOS switch is disposed, a signal line through which a control signal for turning on/off the switch is supplied is necessary. However, the signal can be simultaneously read out from two adjacent pixel rows, and hence adjacent pixels can share the signal line, and a signal line through which a driving signal is supplied to the signal read circuits. As a result, a wiring space can be reduced, the light-receiving area can be expanded, and the pixel number can be increased.

In the solid-state imaging device of the invention, the driving signal comprises: a control signal for controlling turning on/off of the MOS switch; a reset signal for resetting the signal read circuit; and a row-selection signal for selecting the read pixel row, the signal read circuit comprises: a MOS row-selection transistor; a MOS reset transistor; and a MOS output transistor, the solid-state imaging device further comprises: a control signal line which is formed between two pixel rows constituting the read pixel row to extend in the row direction, and through which the control signal is supplied to the MOS switch; a reset signal line which is formed between read pixel rows to extend in the row direction, and through which the reset signal is supplied to the reset transistor; and a row-selection signal line which is formed between the read pixel rows to extend in the row direction, and through which the row-selection signal is supplied to the row-selection transistor, and the control signal line and the signal line are commonly connected to pixels of two pixel rows between which the control signal line and the signal line are interposed.

According to the configuration, the number of the signal lines can be reduced, the light-receiving area can be expanded, and the pixel pitch can be further shortened, so that an increased number of pixels and high sensitivity can be realized.

In the solid-state imaging device of the invention, the driving signal comprises: a control signal for controlling turning on/off of said MOS switch; and a reset signal for resetting the signal read circuit, the signal read circuit comprises: a MOS reset transistor; and a MOS output transistor, wherein the imaging device further comprises: a control signal line which is formed between two pixel rows constituting the read pixel row to extend in the row direction, and through which the control signal is supplied to said MOS switch; and a reset signal line which is formed between read pixel rows to extend in the row direction, and through which the reset signal is supplied to the reset transistor, and the control signal line and the reset signal line are commonly connected to pixels of two pixel rows between which the control signal line and the reset signal line are interposed.

According to the configuration, the number of the signal lines can be reduced, the light-receiving area can be expanded, and the pixel pitch can be shortened, so that an increased number of pixels and high sensitivity can be realized.

In the solid-state imaging device of the invention, the first signal processing section and the second signal processing section simultaneously output signals obtained from one pixel, from output terminals which are disposed respectively for color components of the signals.

In the solid-state imaging device of the invention, the first signal processing section and the second signal processing section output signals obtained from one pixel in a time sharing manner, from one output terminal.

According to the configuration, the number of terminals can be reduced.

In the solid-state imaging device of the invention, the first signal processing section and the second signal processing section are formed respectively at positions which are opposed to each other across said plurality of pixels on the semiconductor substrate.

According to the configuration, wirings can be easily laid.

### BRIEF DESCRIPTION OF THE DRAWINGS

FIG. 1 is a surface diagram showing the configuration of a hybrid solid-state imaging device illustrating a first embodiment of the invention;

FIGS. 2A and 2B are diagrams schematically showing the configuration of one pixel shown in FIG. 1;

FIGS. 3A and 3B are views showing a circuit configuration in the case where a signal read circuit shown in FIGS. 2A and 2B is configured by three transistors;

FIG. 4 is a surface diagram showing the configuration of a hybrid solid-state imaging device illustrating a second embodiment of the invention;

FIG. 5 is a diagram schematically showing the configuration of two pixels which are adjacent to each other in the column direction in the solid-state imaging device shown in FIG. 4; and

FIG. 6 is a view showing a circuit configuration in the case where a signal read circuit shown in FIG. 5 is configured by two transistors.

### DETAILED DESCRIPTION OF THE INVENTION

Hereinafter, embodiments of the invention will be described with reference to the accompanying drawings.

### First Embodiment

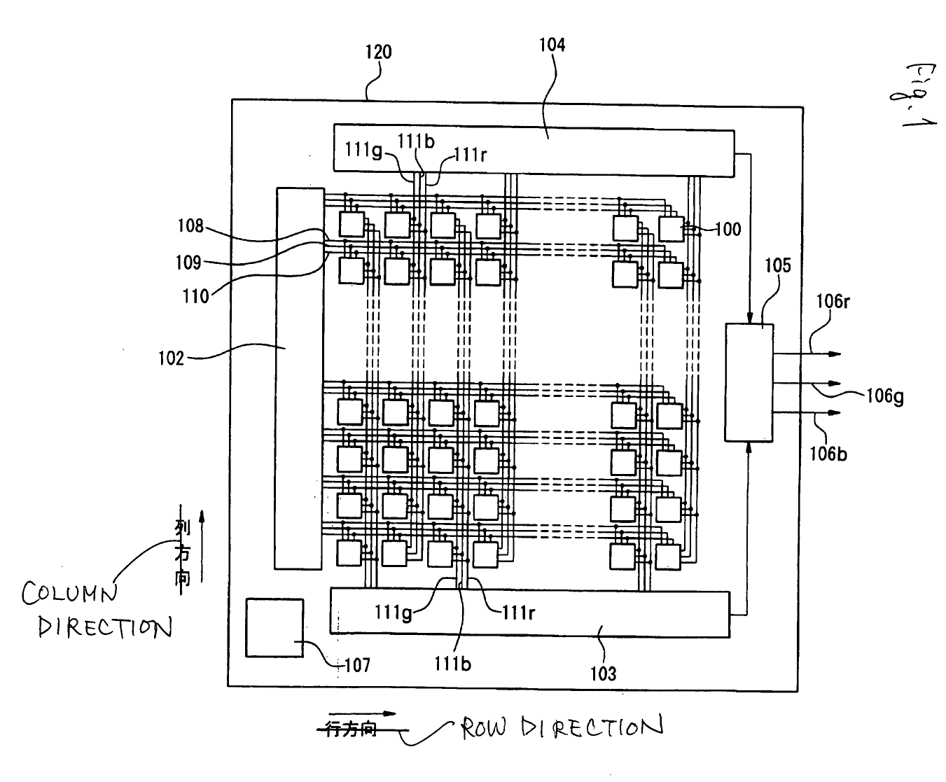

FIG. 1 is a surface diagram showing the configuration of a hybrid solid-state imaging device illustrating a first embodiment of the invention.

The solid-state imaging device shown in FIG. 1 comprises many pixels 100 which are arranged a square lattice pattern in a row direction in the figure and a column direction perpendicular to the row direction. The many pixels 100 are arranged so that a row configured by plural pixels 100 which are arranged in the row direction is set as a pixel row, and a large number of such pixel rows are arranged in the column direction, or that a column configured by plural pixels 100 which are arranged in the column direction is set as a pixel column, and a large number of such pixel columns are arranged in the row direction. Each of the pixels 100 includes: a light receiving portion which detects lights of R, G, and B to generate signal charges corresponding to the detected lights, and which accumulate the signal charges; and a signal read circuit configured by MOS transistors for reading out signals corresponding to the signal charges which are accumulated in the light receiving portion.

On an n-type silicon substrate 120, formed are: a row-selection scanning section 102 (corresponding to the driving signal supplying section in the claims) which supplies a driving signal for driving the signal read circuits included in the pixels 100, to the signal read circuits; a signal processing section 103 (corresponding to the first signal processing section in the claims) which applies a signal process such as correlation dual sampling or an A/D conversion process on three color signals of R, G, and B read out from the signal read circuits (corresponding to the first signal read circuits in the claims) of the pixels 100 included in pixel columns that are odd-numbered with counting from the left end of the solid-state imaging device shown in FIG. 1 (hereinafter, such pixel columns are referred to as odd pixel columns); a signal processing section 104 (corresponding to the second signal processing section in the claims) which applies the signal process on three color signals of R, G, and B read out from the signal read circuits (corresponding to the second signal read circuits in the claims) of the pixels 100 included in pixel columns that are even-numbered with counting from the left end of the solid-state imaging device shown in FIG. 1 (hereinafter, such pixel columns are referred to as even pixel columns); a signal combining section 105 which combines a signal processed by the signal processing section 103 with that processed by the signal processing section 104, and which outputs the combined signal; and a controlling section 107 which produces a timing pulse for driving the light receiving portions included in the pixels 100, which supplies the timing pulse to the light receiving portions, and which controls the row-selection scanning section 102, the signal processing sections 103, 104, and the signal combining section 105.

The signal processing sections 103, 104 are formed respectively at positions which are opposed to each other across the area where the many pixels 100 are formed. Alternatively, the signal processing sections 103, 104 may be configured so that an A/D conversion process is not performed, and analog signals are output. In the embodiment, the odd pixel columns are equal in number to the even pixel columns.

On the n-type silicon substrate 120, three kinds of signal lines (a read signal line 108, a reset signal line 109, and a row-selection line 110) for supplying driving signals for driving the signal read circuits included in the pixels 100 are formed to extend between pixel rows in the row direction. Sets each consisting of the read signal line 108, the reset signal line 109, and the row-selection line 110 are disposed correspondingly with the respective pixel rows. The read signal line 108, the reset signal line 109, and the row-selection line 110 are connected to the signal read circuits of the pixels 100 included in the pixel row corresponding to the signal lines, and also to the row-selection scanning section 102. The signal reading operation of the signal read circuits is controlled by supplying the driving signal from the row-selection scanning section 102 to the signal read circuits through the read signal line 108, the reset signal line 109, and the row-selection line 110.

The row-selection scanning section 102 performs a control so that the pixel rows which are sequentially arranged from the upper end side of the solid-state imaging device shown in FIG. 1 are sequentially selected one by one, and signals are read out in the unit of one pixel row.

On the n-type silicon substrate 120, three kinds of signal lines (a color column signal line 111r, a color column signal line 111g, and a color column signal line 111b) for transmitting the color signals of R, G, and B read out from the signal read circuits included in the pixels 100 to the signal processing sections 103, 104 are formed to extend between pixel columns in the column direction. The color column signal lines 111r, 111g, and 111b are disposed correspondingly with the pixel columns. The color column signal lines 111g, 111b, and 111r are connected to the signal read circuits of the pixels 100 included in the pixel column corresponding to the signal lines, and also to the signal processing sections 103, 104. In the embodiment, the color column signal lines 111g, 111b, and 111r which correspond to odd pixel columns are connected to the signal processing section 103, and the color column signal lines 111g, 111b, and 111r which correspond to even pixel columns are connected to the signal processing section 104.

For each set of the signal lines (the color column signal line 111g, the color column signal line 111b, and the color column signal line 111r) connected to an odd pixel column, the signal processing section 103 has a signal process circuit unit for performing a signal process on color signals obtained from the signal lines.

For each set of the signal lines (the color column signal line 111g, the color column signal line 111b, and the color column signal line 111r) connected to an even pixel column, the signal processing section 104 has a signal process circuit unit for performing a signal process on color signals obtained from the signal lines.

When focused on color signals obtained from one pixel row, each of the signal processing sections 103, 104 skippingly outputs the signals obtained from the pixels 100 included in one pixel row. In the embodiment, in order to enable signals read out from the pixels 100 included in one pixel row to be output in the sequence of the arrangement of the pixels from which the signals are originated, therefore, the signal combining section 105 performs a process of combining color signals which are obtained from the one pixel row and output by the signal processing section 103, with those which are obtained from the one pixel row and output by the signal processing section 104.

The signal combining section 105 simultaneously outputs color signals for one pixel from output terminals which are disposed respectively for the color signals of R, G, and B. The R signals obtained from the pixels 100 are output from an output terminal 106r, the G signals obtained from the pixels 100 are output from an output terminal 106g, and the B signals obtained from the pixels 100 are output from an output terminal 106b. Alternatively, only one output terminal may be disposed, and color signals for one pixel may be output in a time sharing manner. In the alternative, the number of output terminals can be reduced, and the production cost can be lowered.

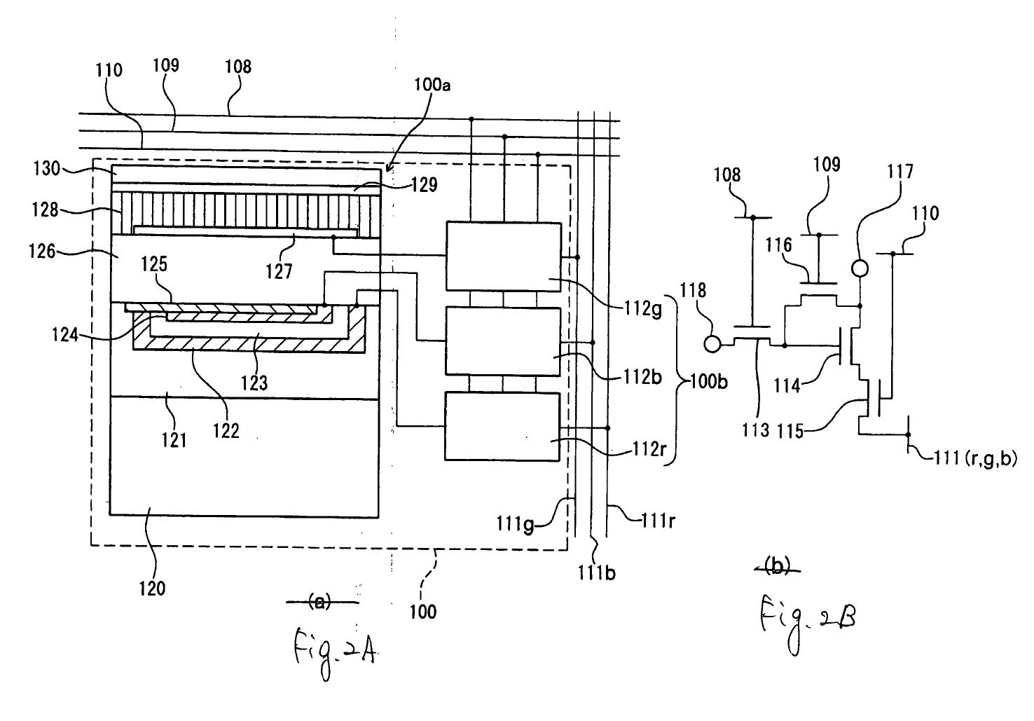

FIG. 2 is a diagram schematically showing the configuration of one pixel shown in FIG. 1. FIG. 2A is a view schematically showing a section of a light receiving portion, and a signal read circuit connected to the portion, and FIG. 2B is a view showing a specific configuration example of the signal read circuit shown in FIG. 2A. As shown in FIG. 2, the pixel 100 includes the light receiving portion 100a and the signal read circuit 100b.

A p-well layer 121 is formed in a surface portion of the n-type silicon substrate 120. In the p-well layer 121, a p⁺-semiconductor layer 125, an n-semiconductor layer 124, a p-semiconductor layer 123, and an n-semiconductor layer 122 are formed in this sequence in the direction from a shallow position toward a deep position.

A transparent insulating film 126 is stacked on the n-type silicon substrate 120. A pixel electrode film 127 which is partitioned for each light receiving portion 100a is formed on the transparent insulating film 126. The pixel electrode film 127 is formed by a material which is optically transparent or less absorbs light. For example, the film is formed by a metal compound such as ITO or a metal film which is very thin.

A photoelectric converting film 128 which is common to light receiving portions 100a included in all pixels, and which is configured by a single film is stacked on the pixel electrode film 127. The photoelectric converting film 128 is sensitive mainly to light in the wavelength region of green (G), and generates G-signal charges corresponding to the amount of green incident light in the incident light. The photoelectric converting film 128 may have a single-film structure or a multi-film structure, and is formed by, for example, an organic or inorganic material which is sensitive mainly to green, including an inorganic material (silicon or a compound semiconductor, nanoparticles thereof, or the like), an organic semiconductor material or an organic dye.

A transparent common electrode film (an opposing electrode film of the pixel electrode film 127) 129 is formed on the photoelectric converting film 128, and a transparent protective film 130 is formed on the electrode film. The opposing electrode film 129 may be a single film electrode which is common to the light receiving portions 100a included in all pixels, or may be configured by partitioning the film for each light receiving portion 100a in the same manner as the pixel electrode film 127, and commonly connecting the partitioned films. The transparent common electrode film is formed by a material, for example, a metal compound such as ITO, or metal film which is very thin. The material must be optically transparent or less absorb light. When a voltage is applied between the pixel electrode film 127 and the opposing electrode film 129, G-signal charges generated in the photoelectric converting film 128 are accumulated in the pixel electrode film 127.

The portion which is partitioned by the pixel electrode film 127 is a G photoelectric converting element which is sensitive to G light. A pn junction which is formed by the n-semiconductor layer 124, and the p⁺-semiconductor layer 125 and the p-semiconductor layer 123 is close to the surface portion of the silicon substrate 120. In light which reaches the junction, therefore, a light component of blue (B) which has a large light absorption coefficient dominantly exists. Accordingly, the pn junction constitutes a B photoelectric converting element (photodiode) which is sensitive to B light. A pn junction which is formed by the n-semiconductor layer 122, and the p-semiconductor layer 123 and the p-well layer 121 is in a deep portion of the silicon substrate 120. In light which reaches the junction, therefore, a light component of red (R) which has a small light absorption coefficient dominantly exists. Accordingly, the pn junction constitutes an R photoelectric converting element (photodiode) which is sensitive to R light.

To the pixel electrode film 127, connected is an input terminal of a signal read circuit 112g for reading out the G signal corresponding to G-signal charges which have been photoelectrically converted by the photoelectric converting film 128, and which are accumulated in the pixel electrode film. The signal read circuit 112g is formed in the p-well layer 121 and the transparent insulating film 126.

To the n-semiconductor layer 124, connected is an input terminal of a signal read circuit 112b for reading out the B signal corresponding to B-signal charges which have been photoelectrically converted by the B photoelectric converting element, and which are accumulated in the layer. The signal read circuit 112b is formed in the p-well layer 121 and the transparent insulating film 126.

To the n-semiconductor layer 122, connected is an input terminal of a signal read circuit 112r for reading out the R signal corresponding to R-signal charges which have been photoelectrically converted by the R photoelectric converting element, and which are accumulated in the layer. The signal read circuit 112r is formed in the p-well layer 121 and the transparent insulating film 126.

The signal read circuits 112r, 112g, 112b are formed by a known 4-transistor configuration, and have the same configuration. In the specification, therefore, the circuit configuration of the signal read circuit 112g will be described.

As shown in FIG. 2B, the signal read circuit 112g comprises: a read transistor 113; an output transistor 114 which converts signal charges to a color column signal; a row-selection transistor 115 for selecting a pixel row; and a reset transistor 116 which resets signal charges. In order to avoid color mixture due to entering of light, these transistors are formed in the p-well layer 121 which is covered by a light shielding film (not shown).

In the read transistor 113, the gate is connected to the read signal line 108, and the source is connected to an input terminal 118. In the output transistor 114, the gate is connected to the drain of the read transistor 113, and the drain is connected to a power source terminal 117. In the reset transistor 116, the gate is connected to the reset signal line 109, the source is connected to the drain of the read transistor 113, and the drain is connected to the power source terminal 117. In the row-selection transistor 115, the gate is connected to the row-selection line 110, the drain is connected to the source of the output transistor 114, and the source is connected to the color column signal line 111g. In the case of the signal read circuit 112r, the configuration is different only in that the source of the row-selection transistor 115 is connected to the color column signal line 111r, and, in the case of the signal read circuit 112b, the configuration is different only in that the source of the row-selection transistor 115 is connected to the color column signal line 111b.

In the thus configured solid-state imaging device, after an exposure period is ended, the row-selection scanning section 102 supplies a row-selection signal to the row-selection line 110, to select an m-th (m is an integer) pixel row. Then, a read signal is supplied to the read signal line 108. As a result, the G-signal charges accumulated in the pixel electrode film 127 are accumulated in a gate portion of the output transistor 114, and the G signal corresponding to the amount of the G-signal charges is read out to the color column signal line 111g. Similarly, the B-signal charges accumulated in the n-semiconductor layer 124 are accumulated in a gate portion of the output transistor 114, and the B signal corresponding to the amount of the B-signal charges is read out to the color column signal line 111b, and the R-signal charges accumulated in the n-semiconductor layer 122 are accumulated in a gate portion of the output transistor 114, and the R signal corresponding to the amount of the R-signal charges is read out to the color column signal line 111r.

Then, the signal processing sections 103, 104 perform a signal process, and the signal combining section 105 outputs signals obtained from the pixel rows, in the sequence of the arrangement of pixels from which the signals are originated.

As described above, the solid-state imaging device which has been described in the embodiment, the signal processing section which applies a signal process on the signals read out from the many pixels 100 is divided into two sections, and configured so that the odd pixel columns are connected to the signal processing section 103, and the even pixel columns are connected to the signal processing section 104. Therefore, an area in the signal processing section which can be ensured for forming one signal process circuit unit included in the signal processing sections can be doubled as compared with the related-art configuration in which only one signal processing section is disposed. In the case where the number of pixels is increased without enlarging the chip size, when only one signal processing section is disposed, the above-mentioned area must be made smaller, and this is hardly realized because of the above-mentioned reason. By contrast, in the solid-state imaging device which has been described in the embodiment, the above-described area can be doubled. Even when the number of pixels is increased, therefore, the increase can be easily realized.

The device is not restricted to the configuration where half of the many pixels 100 are connected to the signal processing section 103, and the other half are connected to the signal processing section 104. As far as a configuration where a part of the many pixels 100 and the remaining part of the pixels 100 other than the part are connected to different signal processing sections is employed, the above-mentioned area can be made large, and the increase of the pixel number can be easily realized.

In the embodiment, the signal processing sections 103, 104 are formed respectively at the positions which are opposed to each other across the area where the many pixels 100 are formed. The positions of the signal processing sections 103, 104 can be arbitrarily determined as far as they are within the chip. In the case where they are placed as shown in FIG. 1, it is possible to attain an effect that the color column signal lines 111r, 111g, 111b can be easily laid.

In the embodiment, each of the signal read circuits 112r, 112g, 112b is configured by four transistors. The invention is not restricted to this configuration. For example, each signal read circuit may be configured by three transistors.

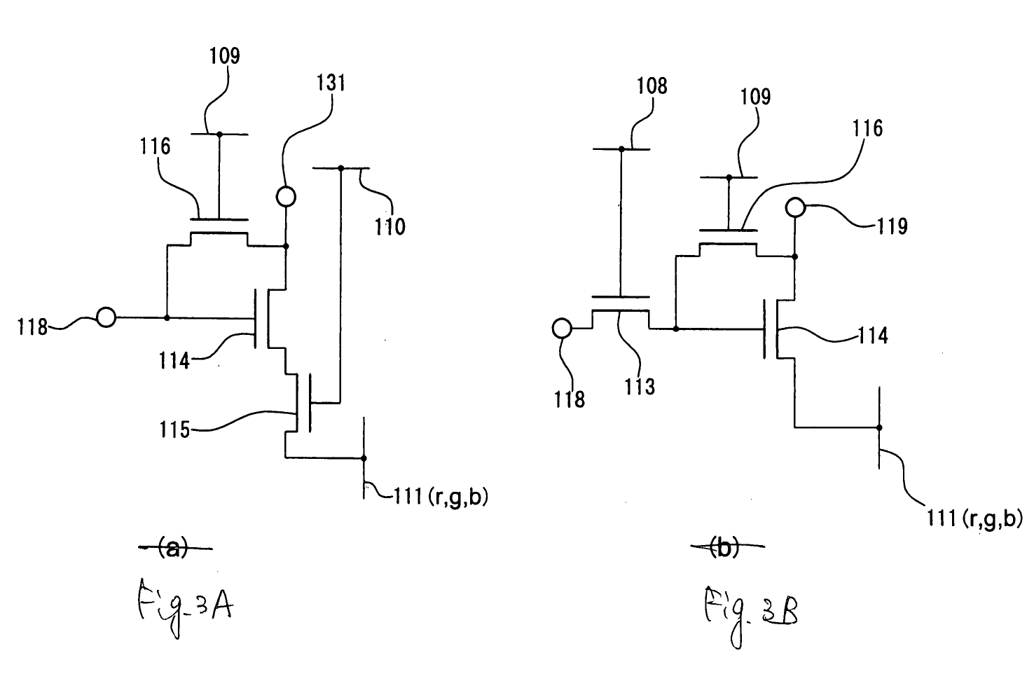

FIG. 3 is a view showing a circuit configuration in the case where each signal read circuit is configured by three transistors. In FIG. 3, the components identical with those of FIG. 2B are denoted by the same reference numerals.

The signal read circuits shown in FIG. 2 may be modified so as to have a configuration in which, as shown in FIG. 3A, the read transistor 113 is omitted, or a configuration in which, as shown in FIG. 3B, a power source terminal 119 connected to the drain of the output transistor 114 is pulse-driven and the row-selection transistor 115 is omitted. In the case of a solid-state imaging device having a configuration such as shown in FIG. 1, two signal processing sections are disposed, and hence the size in the column direction is large. In both the configurations of FIGS. 3A and 3B, the number of signal lines from the row-selection scanning section 102 can be reduced to two, and hence the size in the column direction can be reduced, so that the size of the solid-state imaging device can be prevent from expanding in the column direction.

### Second Embodiment

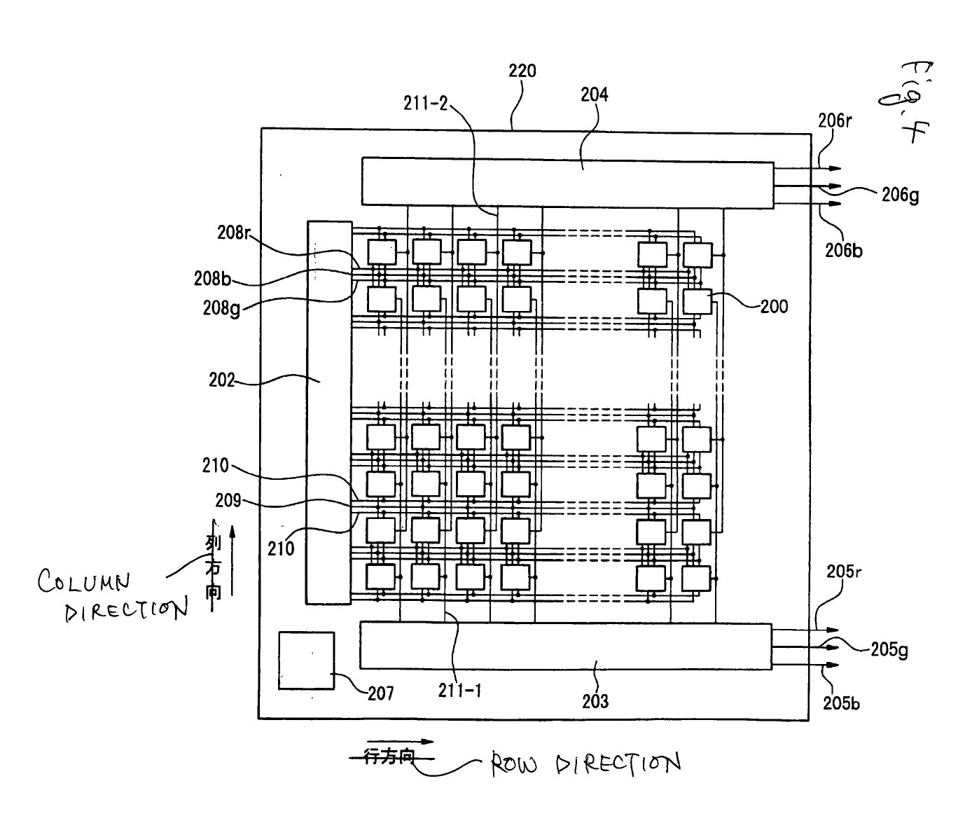

FIG. 4 is a surface diagram showing the configuration of a hybrid solid-state imaging device illustrating a second embodiment of the invention.

The solid-state imaging device shown in FIG. 4 comprises many pixels 200 which are arranged in a square lattice pattern in a row direction in the figure and a column direction perpendicular to the row direction. The many pixels 200 are arranged so that pixel rows each configured by plural pixels 200 which are arranged in the row direction are arranged in the column direction, or that pixel columns each configured by plural pixels 200 which are arranged in the column direction are arranged in the row direction. Each of the pixels 200 includes: a light receiving portion which is configured in the same manner as that described in the first embodiment; a signal read circuit configured by MOS transistors for reading out color signals corresponding to the signal charges which are accumulated in the light receiving portion; and a MOS switch for selectively outputting color signals corresponding to the signal charges which are accumulated in the light receiving portion, from the signal read circuit.

On an n-type silicon substrate 220, formed are: a row-selection scanning section 202 (corresponding to the driving signal supplying section in the claims) which supplies a driving signal for driving the signal read circuits and the MOS switches included in the pixels 200, to the signal read circuits and the MOS switches; a signal processing section 203 (corresponding to the first signal processing section in the claims) which applies a signal process such as correlation dual sampling or an A/D conversion process on three color signals of R, G, and B read out from the signal read circuits (corresponding to the first signal read circuit in the claims) of the pixels 200 included in pixel rows that are even-numbered with counting from the upper end of the solid-state imaging device shown in FIG. 4 (hereinafter, referred to as even pixel rows); a signal processing section 204 (corresponding to the second signal processing section in the claims) which applies the signal process on three color signals of R, G, and B read out from the signal read circuits (corresponding to the second signal read circuit in the claims) of the pixels 200 included in pixel rows that are odd-numbered with counting from the upper end of the solid-state imaging device shown in FIG. 4 (hereinafter, referred to as odd pixel rows); and a controlling section 207 which produces a timing pulse for driving the light receiving portions included in the pixels 200, which supplies the timing pulse to the light receiving portions, and which controls the row-selection scanning section 202, and the signal processing sections 203, 204.

The signal processing sections 203, 204 are formed respectively at positions which are opposed to each other across the area where the many pixels 200 are formed. Alternatively, the signal processing sections 203, 204 may be configured so that an A/D conversion process is not performed, and analog signals are output. In the embodiment, the odd pixel rows are equal in number to the even pixel rows.

On the n-type silicon substrate 220, five kinds of signal lines (a read signal line 208r, a read signal line 208g, a read signal line 208b, a reset signal line 209, and a row-selection line 210) for supplying driving signals are formed to extend from the row-selection scanning section 202 in the row direction. The read signal lines 208r, 208g, 208b correspond to the control signal line in the claims.

The row-selection scanning section 202 performs a control so that the pixel rows which are sequentially arranged from the upper end side of the solid-state imaging device shown in FIG. 4 are sequentially selected in the unit of a read pixel row which is configured by two pixel rows adjacent to each other in the column direction, and signals are read out.

A set of the read signal lines 208r, 208g, 208b is formed so as to extend in the row direction between two pixel rows which constitute a read pixel row, and connected commonly to pixels included in the two pixel rows. A set of the reset signal line 209 and the row-selection line 210 is formed so as to extend in the row direction between read pixel rows. The reset signal line 209 is connected commonly to pixels included in the two pixel rows between which the reset signal line is interposed. Each set of the reset signal line 209 and the row-selection line 210 is connected also to the pixel row which is in the uppermost side of the solid-state imaging device shown in FIG. 4, and that which is in the lowermost side. In this case, the reset signal lines 209 and the row-selection lines 210 are not used commonly to the two pixel rows.

The row-selection scanning section 202 supplies the driving signal to the pixels through the read signal lines 208r, 208g, 208b, the reset signal line 209, and the row-selection line 210, thereby controlling the signal reading operation of the signal read circuits. The row-selection scanning section 202 sequentially selects read pixel rows each consisting of a (2n−1)-th (n is a positive integer) pixel row from the upper end side of the solid-state imaging device shown FIG. 4, and a 2n-th pixel row, causes only the signal read circuits included in the selected two pixel rows to operate, and sequentially turns on and off the MOS switches included in the selected two pixel rows so that the color signals of R, G, and B are read out from the pixels included in the selected two pixel rows to the signal processing sections 203, 204.

On the n-type silicon substrate 220, two kinds of signal lines (a color column signal line 211-1 and a color column signal line 211-2) for transmitting the color signals of R, G, and B read out in a time sharing manner from the signal read circuits included in the pixels 200 to the signal processing sections 203, 204 are formed to extend between pixel columns in the column direction. The color column signal lines 211-1, 211-2 are disposed correspondingly with the pixel columns. The color column signal line 211-1 is connected to the signal read circuits of pixels which are included in the pixel column corresponding to the signal line and in even pixel rows, and also to the signal processing section 203. The color column signal line 211-2 is connected to the signal read circuits of pixels which are included in the pixel column corresponding to the signal line and in odd pixel rows, and also to the signal processing section 204.

For each of the color column signal lines 211-1 corresponding to the pixel columns, the signal processing section 203 is configured so as to have a signal process circuit unit for performing a signal process on three color signals obtained from the color column signal line 211-1. The signal processing section 203 simultaneously outputs color signals of R, G, and B obtained from pixels included in one pixel row after the signal process, from output terminals (205r, 205g, 205b) which correspond respectively to the color signals. The sequence of outputting the signals from the output terminals is identical with that of the arrangement of pixels included in the selected pixel row, in the row direction. The R signal is output from the terminal 205r, the G signal is output from the terminal 205g, and the B signal is output from the terminal 205b.

For each of the color column signal lines 211-2 corresponding to the pixel columns, the signal processing section 204 is configured so as to have a signal process circuit unit for performing a signal process on three color signals obtained from the color column signal line 211-2. The signal processing section 204 simultaneously outputs color signals of R, G, and B obtained from pixels included in one pixel row after the signal process, from output terminals (206r, 206g, 206b) which correspond respectively to the color signals. The sequence of outputting the signals from the output terminals is identical with that of the arrangement of pixels included in the selected pixel row, in the row direction. The R signal is output from the terminal 206r, the G signal is output from the terminal 206g, and the B signal is output from the terminal 206b.

In the signal processing sections 203, 204, the output terminal may be combined to one terminal so as to output color signals for one pixel in a time sharing manner. According to the configuration, the number of output terminals can be reduced, and the production cost can be lowered.

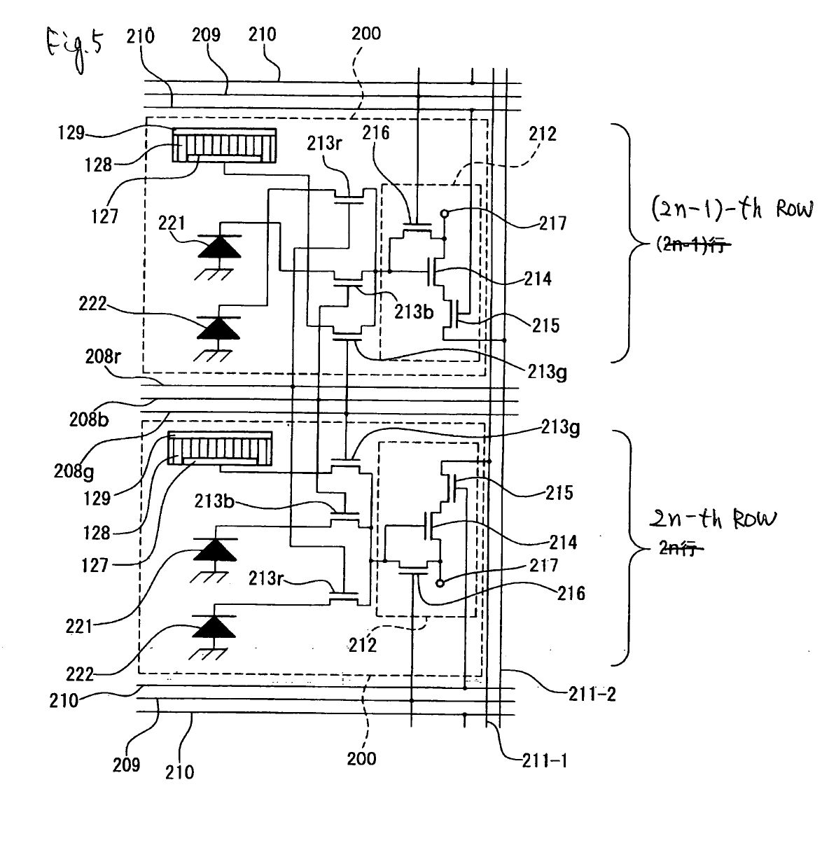

FIG. 5 is a diagram schematically showing the configuration of two pixels which are adjacent to each other in the column direction in the solid-state imaging device shown in FIG. 4. FIG. 5 shows two pixels or a pixel in a (2n−1)-th pixel row from the upper end side of the solid-state imaging device shown FIG. 4, and that in a 2n-th pixel row and adjacent thereto in the column direction. The two pixels are pixels which are simultaneously selected in the signal reading operation. The light receiving portions included in the pixels 200 shown in FIG. 5 are configured in the same manner as FIG. 2, and the components identical with those of FIG. 2 are denoted by the same reference numerals. In FIG. 5, the B photoelectric converting element formed in the silicon substrate 220 is denoted by the reference numeral 221, and the R photoelectric converting element is denoted by the reference numeral 222.

As shown in FIG. 5, the pixel 200 of the (2n−1)-th pixel row comprises: a light receiving portion; a signal read circuit 212 for reading out signals corresponding to the signal charges which are accumulated in the light receiving portion; and MOS switches 213r, 213g, 213b for selectively outputting the color signals of R, G, and B corresponding to the signal charges which are accumulated in the light receiving portion, to the signal read circuit 212.

In the MOS switch 213r, the gate is connected to the read signal line 208r, the source is connected to the R photoelectric converting element 222, and the drain is connected to the input of the signal read circuit 212. In the MOS switch 213g, the gate is connected to the read signal line 208g, the source is connected to the pixel electrode film 127, and the drain is connected to the input of the signal read circuit 212. In the MOS switch 213b, the gate is connected to the read signal line 208b, the source is connected to the B photoelectric converting element 221, and the drain is connected to the input of the signal read circuit 212.

The signal read circuit 212 comprises: an output transistor 214 which converts signal charges to a color column signal; a row-selection transistor 215 for selecting a read pixel row; and a reset transistor 216 which resets signal charges read into the signal read circuit 212. The row-selection transistor 215 operates in accordance with the row-selection signal for selecting a read pixel row. The reset transistor 216 operates in accordance with a reset signal for resetting signal charges.

In the output transistor 214, the gate is connected to the outputs of the MOS switches 213r, 213g, 213b, and the drain is connected to a power source terminal 217. In the reset transistor 216, the gate is connected to the reset signal line 209, the source is connected to the gate of the output transistor 214, and the drain is connected to the power source terminal 217. In the row-selection transistor 215, the gate is connected to the row-selection line 210, the drain is connected to the source of the output transistor 214, and the source is connected to the color column signal line 211-2.

The pixels 200 of the 2n-th row are similar to those of the (2n−1)-th row except that, in the pixels 200 of the (2n−1)-th row, the drain of the row-selection transistor 215 is connected to the column signal line 211-1.

In the thus configured solid-state imaging device, after an exposure period is ended, the row-selection scanning section 202 supplies a row-selection signal to the row-selection line 210 connected to the (2n−1)-th and 2n-th pixel rows, to select these pixel rows as the read pixel row. Then, a read signal is supplied sequentially to the read signal lines 208r, 208g, 208b to sequentially turn on and off the MOS switches 213r, 213g, 213b. As a result, the color signals of R, G, and B obtained from the 2n-th pixel row are read out to the column signal line 211-1 in a time sharing manner, and the color signals of R, G, and B obtained from the (2n−1)-th pixel row are read out to the column signal line 211-2 in a time sharing manner.

As described above, according to the solid-state imaging device which has been described in the embodiment, the MOS switches 213r, 213g, 213b are disposed in each of the pixels 200, and the signal read circuit can be commonly used in the R photoelectric converting element, the G photoelectric converting element, and the B photoelectric converting element. Therefore, only one column signal line is connected to each of the signal processing sections 203, 204 for each pixel column, and the number of signal process circuit units included in the signal processing sections can be reduced to one third of that in the case where three column signal lines are connected for each pixel column. Even when the pixel number is increased, therefore, the signal processing sections can be easily formed.

The solid-state imaging device which has been described in the embodiment is configured so that the signal read circuit is commonly used in the photoelectric converting elements, and hence the number of signal lines existing between pixel columns can be reduced to two. As compared with the related-art case where three signal lines exist between pixel columns, therefore, the light-receiving area of the light receiving portion can be expanded, and high sensitivity can be realized. In the case of a hybrid solid-state imaging device, although the light-receiving area of the G photoelectric converting element is originally large and hence a large effect cannot be expected, the light-receiving areas of the R and B photoelectric converting elements are made large so that the S/N ratios of the R and B signals are enhanced. Therefore, the S/N ratios of the R, G, and B signals can be improved, and an excellent image quality can be obtained.

The solid-state imaging device which has been described in the embodiment is configured so that the signal read circuit is commonly used in the photoelectric converting elements, and hence the number of transistors included in one pixel can be reduced. In comparison to a configuration where three signal read circuits are disposed in a pixel, the number of transistors in a pixel in the solid-state imaging device which has been described in the embodiment can be reduced by six as compared with the case where each signal read circuit is configured by four transistors, or by three as compared with the case where each signal read circuit is configured by three transistors. Accordingly, the light-receiving area in a pixel can be expanded, and high sensitivity can be realized.

The solid-state imaging device which has been described in the embodiment is configured so that different signal processing sections are connected to an odd pixel row and an even pixel row, and the signal reading operation is performed for each two pixel rows adjacent to each other in the column direction. Therefore, the read signal lines 208r, 208g, 208b and the reset signal line 209 can be commonly used by adjacent pixels. In the case where only one signal processing section is disposed, three read signal lines, a reset signal line, and a row-selection line must be formed correspondingly to one pixel row, and hence the size in the column direction must be expanded, or the pixel number in the column direction must be reduced. According to the embodiment, it is possible to prevent such a situation from occurring.

According to the solid-state imaging device which has been described in the embodiment, when one of the signal processing sections 203, 204 is not operated, only color signals which are originated from one of an odd pixel row and an even pixel row can be output. The embodiment can be preferably applied to a digital camera having a motion picture mode, etc.

In the embodiment, the signal read circuit 212 is configured by three transistors. The invention is not restricted to this. For example, the circuit may be configured by two transistors.

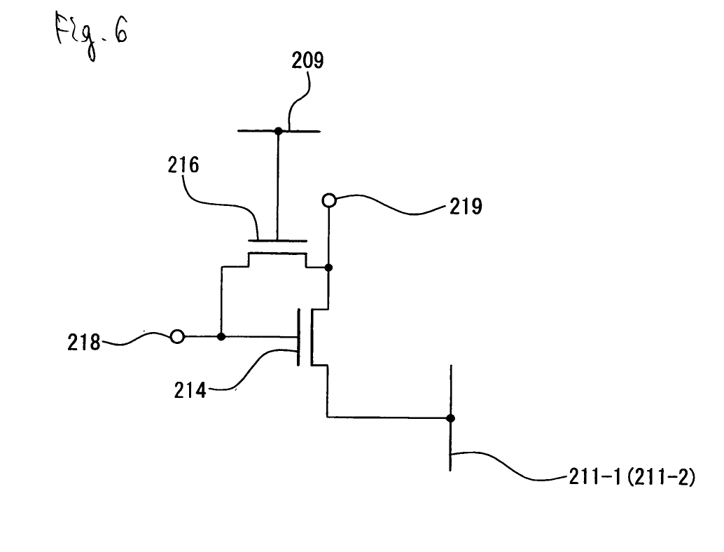

FIG. 6 is a view showing a circuit configuration in the case where a signal read circuit is configured by two transistors. In FIG. 6, the components identical with those of FIG. 5 are denoted by the same reference numerals.

The signal read circuit shown in FIG. 6 has a configuration in which the row-selection transistor 215 shown in FIG. 5 is omitted. The source of the reset transistor 216, and the gate of the output transistor 214 are connected to an input terminal 218 to which the output of the MOS switch is connected. A power source terminal 219 is connected to the drain of the reset transistor 216 and the drain of the output transistor 214. The source of the output transistor 214 is connected to the column signal line 211-1 or 211-2. When the power source terminal 219 is pulse-driven, the signal read circuit operates, and a signal corresponding to signal charges accumulated in the vicinity of the gate of the output transistor 214 flows through the column signal line 211-1 (211-2).

According to the configuration, the light-receiving area of a pixel can be further expanded, and the row-selection line 210 shown in FIG. 5 can be omitted. Therefore, the pixel area can be widened, and the number of pixels can be increased. As a result, further enhanced high sensitivity, and a further increased number of pixels can be realized.

According to the invention, an increased number of pixels and high sensitivity can be easily realized in a hybrid solid-state imaging device.

The entire disclosure of each and every foreign patent application from which the benefit of foreign priority has been claimed in the present application is incorporated herein by reference, as if fully set forth.

What is claimed is:

1. A solid-state imaging device comprising
a plurality of pixels which are arranged in a row direction and a column direction perpendicular to the row direction, wherein
each of said plurality of pixels comprises:
(i) a light receiving portion including
a plurality of photoelectric converting elements which are formed overlappingly in a depth direction of a semiconductor substrate, and which detect lights of different colors respectively, and
a photoelectric converting film which is stacked above the plural photoelectric converting elements in the semiconductor substrate, and which detects a light of a color different from the colors that are detected by said plurality of photoelectric converting elements; and
(ii) a signal read circuit which reads out signals corresponding to the lights that are detected by said plurality of photoelectric converting elements and the photoelectric converting film,
wherein the solid-state imaging device comprises:
a first signal processing section which applies a predetermined signal process on signals read out from first signal read circuits that are signal read circuits included in a part of said plurality of pixels; and
a second signal processing section which applies the predetermined signal process on signals read out from second signal read circuits that are signal read circuits included in pixels other than the part of said plurality of pixels.

2. A solid-state imaging device according to claim 1,
wherein, when a column comprising those of said plurality of pixels arranged in the column direction is indicated as a pixel column and a row comprising those of said plurality of pixels arranged in the row direction is indicated as a pixel row,
said plurality of pixels comprises a plurality of pixel columns arranged in the row direction or comprises a plurality of pixel rows arranged in the column direction,
the part of said plurality of pixels comprises pixels included in a part of said plurality of pixel columns,
the solid-state imaging device further comprises:
a driving signal supplying section that supplies to the signal read circuit a driving signal for driving the signal read circuit so as to read out signals from the pixels, in a unit of one pixel row; and
a signal combining section that combines an output signal of the first signal processing section with an output signal of the second signal processing section so as to output signals obtained from the one pixel row which has been processed by the first signal processing section and the second signal processing section, in a sequence of pixels from which the signals are originated.

3. A solid-state imaging device according to claim 2,
wherein the signal combining section simultaneously outputs signals obtained from one pixel, from output terminals which are disposed respectively for color components of the signals.

4. A solid-state imaging device according to claim 2,
wherein the signal combining section outputs signals obtained from one pixel in a time sharing manner, from one output terminal.

5. A solid-state imaging device according to claim 2,
wherein the part of said plurality of pixel columns is a half of said plurality of pixel columns.

6. A solid-state imaging device according to claim 1,
wherein the signal read circuit comprises three or four MOS transistors.

7. A solid-state imaging device according to claim 1,
wherein, when a column comprising those of said plurality of pixels arranged in the column direction is indicated as a pixel column and a row comprising those of said plurality of pixels arranged in the row direction is indicated as a pixel row,
said plurality of pixels comprises a plurality of pixel columns arranged in the row direction or comprises a plurality of pixel rows arranged in the column direction,
the part of said plurality of pixels comprises pixels included in a half of said plurality of pixel rows,
pixel rows in which pixels including the first signal read circuits are arranged, and pixel rows in which pixels including the second signal read circuits are arranged are alternately arranged in the column direction,
each of the pixels further comprises a MOS switch that selectively outputs signals corresponding to the lights that are detected by said plurality of photoelectric converting elements and the photoelectric converting film, from the signal read circuit, and
the solid-state imaging device further comprises
a driving signal supplying section that supplies to the MOS switch and the signal read circuit, a driving signal for driving the MOS switch and the signal read circuit so as to sequentially read out signals from the pixels, in a unit of read pixel row comprising two pixel rows adjacent to each other in the column direction.

8. A solid-state imaging device according to claim 7,
wherein the driving signal comprises: a control signal for controlling turning on/off of the MOS switch; a reset signal for resetting the signal read circuit; and a row-selection signal for selecting the read pixel row,
the signal read circuit comprises: a MOS row-selection transistor; a MOS reset transistor; and a MOS output transistor,
the solid-state imaging device further comprises:
a control signal line which is formed between two pixel rows constituting the read pixel row to extend in the row direction, and through which the control signal is supplied to the MOS switch;
a reset signal line which is formed between read pixel rows to extend in the row direction, and through which the reset signal is supplied to the reset transistor; and
a row-selection signal line which is formed between the read pixel rows to extend in the row direction, and through which the row-selection signal is supplied to the row-selection transistor, and
the control signal line and the signal line are commonly connected to pixels of two pixel rows between which the control signal line and the signal line are interposed.

9. A solid-state imaging device according to claim 7,
wherein the driving signal comprises: a control signal for controlling turning on/off of said MOS switch; and a reset signal for resetting the signal read circuit,
the signal read circuit comprises: a MOS reset transistor; and a MOS output transistor,
wherein the imaging device further comprises:
a control signal line which is formed between two pixel rows constituting the read pixel row to extend in the row direction, and through which the control signal is supplied to said MOS switch; and
a reset signal line which is formed between read pixel rows to extend in the row direction, and through which the reset signal is supplied to the reset transistor, and
the control signal line and the reset signal line are commonly connected to pixels of two pixel rows between which the control signal line and the reset signal line are interposed.

10. A solid-state imaging device according to claim 7,
wherein the first signal processing section and the second signal processing section simultaneously output signals obtained from one pixel, from output terminals which are disposed respectively for color components of the signals.

11. A solid-state imaging device according to claim 7,
wherein the first signal processing section and the second signal processing section output signals obtained from one pixel in a time sharing manner, from one output terminal.

12. A solid-state imaging device according to claim 1,
wherein the first signal processing section and the second signal processing section are formed respectively at positions which are opposed to each other across said plurality of pixels on the semiconductor substrate.
